(19) United States
(12) Patent Application Publication
(10) Pub. No.: US 2026/0361183 A1
(43) Pub. Date: Nov. 12, 2026

(54) ELECTRIC MOTOR FOR A POWER TOOL

(71) Applicant: MILWAUKEE ELECTRIC TOOL CORPORATION, Brookfield, WI (US)

(72) Inventors: Caleb M. Schober, Milwaukee, WI (US); Ethan T. Zimany, Kenosha, WI (US); Timothy R. Reichert, Franklin, WI (US); Patrick L. Hottle, West Allis, WI (US); David M. Pittman, Sussex, WI (US)

(21) Appl. No.: 19/670,651

(22) Filed: May 7, 2026

Related U.S. Application Data
(60) Provisional application No. 63/802,173, filed on May 8, 2025.

(51) Int. Cl. H02K 9/22; B25F 5/02; H02K 7/14; H02K 11/33; H02K 21/16

(52) U.S. Cl. CPC H02K 9/227; H02K 7/145; H02K 11/33; H02K 21/16; B25F 5/02; H02K 2211/03

(57) ABSTRACT

An electric motor assembly includes a stator assembly, a rotor assembly, and a circuit board assembly. A heat sink is coupled to the circuit board assembly and includes a main body and an eddy current reduction feature. The eddy current reduction feature may be a magnetic isolator coupled to the main body or a plurality of interrupting notches defined in an end wall of the main body. The heat sink reduces eddy currents induced during operation, improving efficiency and performance. The electric motor assembly may be used in a power tool, which includes a housing, a drive mechanism, and the electric motor assembly. The heat sink's design enables effective heat dissipation and reduced eddy currents, enhancing overall motor performance.

### CROSS-REFERENCE TO RELATED APPLICATIONS

This application claims priority to U.S. Provisional Patent Application No. 63/802,173, filed May 8, 2025, the entire content of which is incorporated herein by reference.

### FIELD OF THE DISCLOSURE

The present disclosure relates to tools, such as power tools, and more particularly to power tools including an electric motor.

### BACKGROUND OF THE DISCLOSURE

Tools, such as power tools, can include an electric motor supported within a housing of the tool.

### SUMMARY OF THE DISCLOSURE

In some aspects, the techniques described herein relate to an electric motor assembly including: a stator assembly including a stator body having a plurality of teeth, and windings wound about the stator body to form a plurality of coils; a rotor assembly configured to rotate relative to the stator assembly; a circuit board assembly coupled to the stator assembly and electrically connected to the windings; and a heat sink coupled to the circuit board assembly, the heat sink including a main body positioned in thermal contact with the circuit board assembly, and a magnetic isolator coupled to the main body, the magnetic isolator configured to reduce eddy currents induced in the main body during operation of the electric motor assembly.

In some aspects, the techniques described herein relate to an electric motor assembly, wherein the main body is formed from a non-ferromagnetic material.

In some aspects, the techniques described herein relate to an electric motor assembly, wherein the magnetic isolator is formed from a ferromagnetic material.

In some aspects, the techniques described herein relate to an electric motor assembly, wherein the magnetic isolator includes a sheet positioned between the main body and the rotor assembly.

In some aspects, the techniques described herein relate to an electric motor assembly, wherein the magnetic isolator defines a central aperture, and wherein the rotor assembly includes a motor shaft that extends through the central aperture.

In some aspects, the techniques described herein relate to an electric motor assembly, wherein the magnetic isolator directly contacts the main body.

In some aspects, the techniques described herein relate to an electric motor assembly, wherein the circuit board assembly is mounted to an end wall of the main body with a thermal pad disposed therebetween.

In some aspects, the techniques described herein relate to an electric motor assembly including: a stator assembly including a stator body having a plurality of teeth, and windings wound about the stator body to form a plurality of coils; a rotor assembly configured to rotate relative to the stator assembly about a rotational axis; a circuit board assembly coupled to the stator assembly and electrically connected to the windings; and a heat sink coupled to the circuit board assembly, the heat sink including an end wall oriented transverse to the rotational axis, the end wall defining: (a) a plurality of primary notches extending radially inward from a peripheral edge of the end wall, and (b) a plurality of secondary notches each communicating with a corresponding primary notch of the plurality of primary notches and extending circumferentially relative to the rotational axis.

In some aspects, the techniques described herein relate to an electric motor assembly, wherein the heat sink is formed from a non-ferromagnetic material.

In some aspects, the techniques described herein relate to an electric motor assembly, wherein the heat sink is formed from aluminum.

In some aspects, the techniques described herein relate to an electric motor assembly, wherein the heat sink is positioned between the circuit board assembly and the rotor assembly.

In some aspects, the techniques described herein relate to an electric motor assembly, wherein the plurality of primary notches and the plurality of secondary notches are configured to reduce eddy currents induced in the heat sink during operation of the electric motor assembly.

In some aspects, the techniques described herein relate to an electric motor assembly, wherein the heat sink further includes cooling fins extending axially from the end wall.

In some aspects, the techniques described herein relate to an electric motor assembly, wherein the heat sink further includes a bearing pocket configured to support a motor bearing, and wherein the primary notches extend from the peripheral edge of the end wall toward the bearing pocket.

In some aspects, the techniques described herein relate to an electric motor assembly, wherein the secondary notches include arcuate recesses extending circumferentially between adjacent primary notches.

In some aspects, the techniques described herein relate to an electric motor assembly, wherein the end wall further defines apertures aligned with position sensors mounted on the circuit board assembly.

In some aspects, the techniques described herein relate to a power tool including: a housing; a drive mechanism supported by the housing; and an electric motor assembly supported within the housing and configured to drive the drive mechanism, the electric motor assembly including: a stator assembly having a stator body and windings wound about the stator body to form a plurality of coils, a rotor assembly configured to rotate relative to the stator assembly, a circuit board assembly electrically connected to the windings, and a heat sink thermally coupled to the circuit board assembly and positioned adjacent the rotor assembly; wherein the heat sink includes a main body and at least one eddy current reduction feature selected from: (a) a magnetic isolator coupled to the main body, or (b) a plurality of interrupting notches defined in an end wall of the main body.

In some aspects, the techniques described herein relate to a power tool, wherein the heat sink further includes a bearing pocket configured to support a motor bearing.

In some aspects, the techniques described herein relate to a power tool, wherein the main body includes an end wall, and wherein the plurality of interrupting notches include: (a) a plurality of primary notches extending radially inward from a peripheral edge of the end wall, and (b) a plurality of secondary notches each communicating with a corresponding primary notch of the plurality of primary notches and extending circumferentially relative to a rotational axis of the rotor assembly.

In some aspects, the techniques described herein relate to a power tool, wherein the magnetic isolator is configured to reduce eddy currents induced in the main body during operation of the electric motor assembly.

Other aspects of the disclosure will become apparent by consideration of the detailed description and accompanying drawings.

### BRIEF DESCRIPTION OF THE DRAWINGS

FIG. 1 is a perspective view of a power tool according to an embodiment of the disclosure.

FIG. 2 is another perspective view of the power tool of FIG. 1.

FIG. 3 is a partially exploded perspective view of the power tool of FIG. 1 with portions removed.

FIG. 4 is a side view of the power tool of FIG. 1 with portions removed.

FIG. 5 is a side view of an electric motor of the power tool of FIG. 1.

FIGS. 6 and 7 are partially exploded perspective views of the motor of FIG. 5.

FIG. 8 is an exploded perspective view of a rotor assembly of the motor assembly of FIG. 5.

FIG. 9 is a perspective view of a stator assembly of the motor of FIG. 5.

FIG. 10 is a perspective view of a portion of a gear case of the power tool of FIG. 1.

FIG. 11 is a perspective view of a heat sink of the motor of FIG. 5.

FIGS. 12 and 13 are exploded perspective views of the heat sink of FIG. 11.

FIGS. 14 and 15 are perspective views of a printed circuit board assembly (PCBA) of the motor of FIG. 5.

FIG. 16 is a perspective view of a heat sink of the motor of FIG. 5 according to another embodiment of the disclosure.

FIG. 17 is a detailed perspective view showing portions of the heat sink of FIG. 16.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

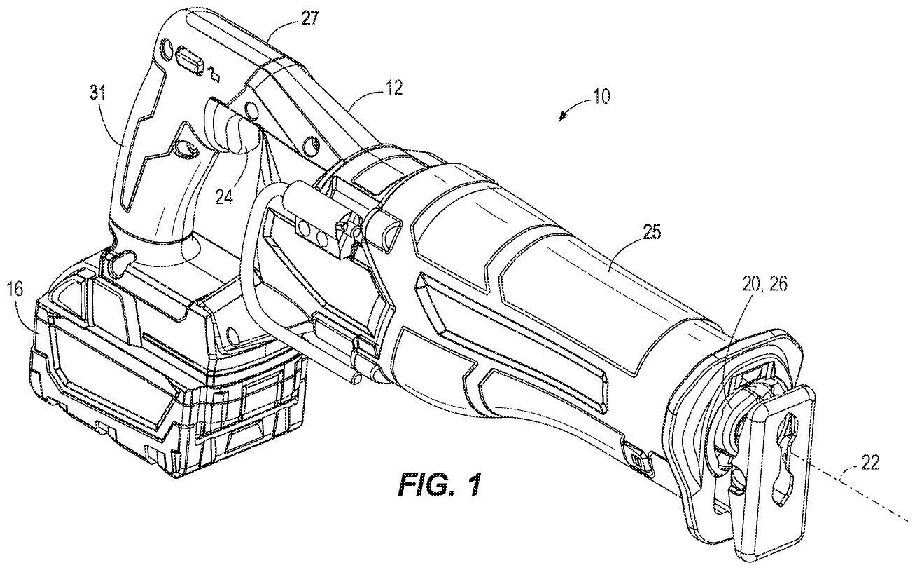

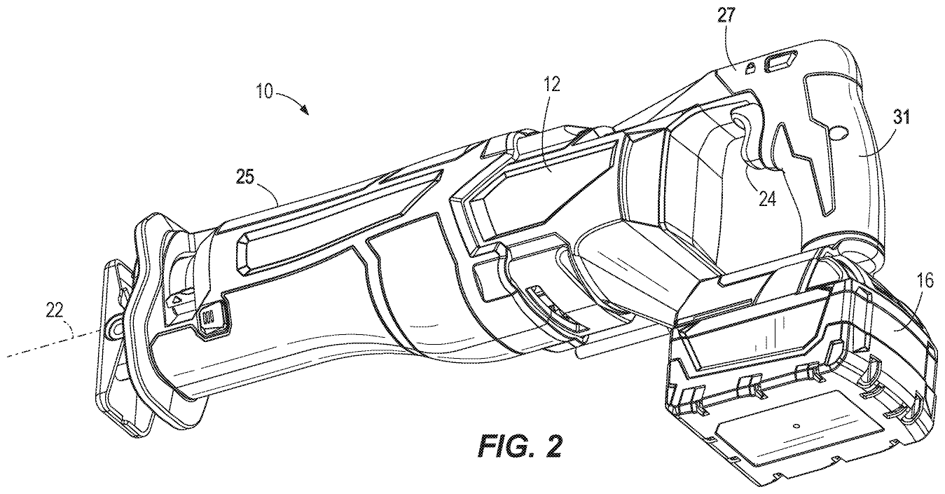

FIGS. 1-3 illustrate a power tool 10 embodied as a saw operable to cut into a workpiece. The power tool 10 includes a housing 12 and a brushless direct current (DC) electric motor 14 supported in the housing 12. The motor 14 is electrically coupled to a rechargeable battery pack 16, which selectively and removably couples to the housing 12. Using power from the battery pack 16, and in response to actuation of a trigger 24, a motor controller (e.g., one or more microprocessors connected to one or more printed circuit boards) operates the motor 14 to drive a drive mechanism 20 to reciprocate along a blade axis 22. The illustrated drive mechanism 20 includes a tool holder 26 that selectively couples a saw blade to the power tool 10 for the motor 14 to drive the saw blade to reciprocate along the blade axis 22. In other embodiments, the electric motor 14 may be used in various different tools, such as other power tools (e.g., drills, rotary hammers, pipe threaders, cutting tools, etc.), outdoor tools (e.g., trimmers, pole saws, blowers, etc.), and other electrical devices (e.g., motorized devices, etc.), with the particular tool including an appropriate drive mechanism in order to carry out the specific function of the tool.

The battery pack 16 may include any of a number of different nominal voltages (e.g., 12V, 18V, etc.). The illustrated battery pack 16 is a lithium-ion battery pack, but in other embodiments, the battery pack 16 can be configured having any of a number of different chemistries (e.g., lead-acid, nickel-cadmium, nickel-metal hydride, etc.). Alternatively, the motor 14 may be powered by a remote power source (e.g., a household electrical outlet) through a power cord (not shown).

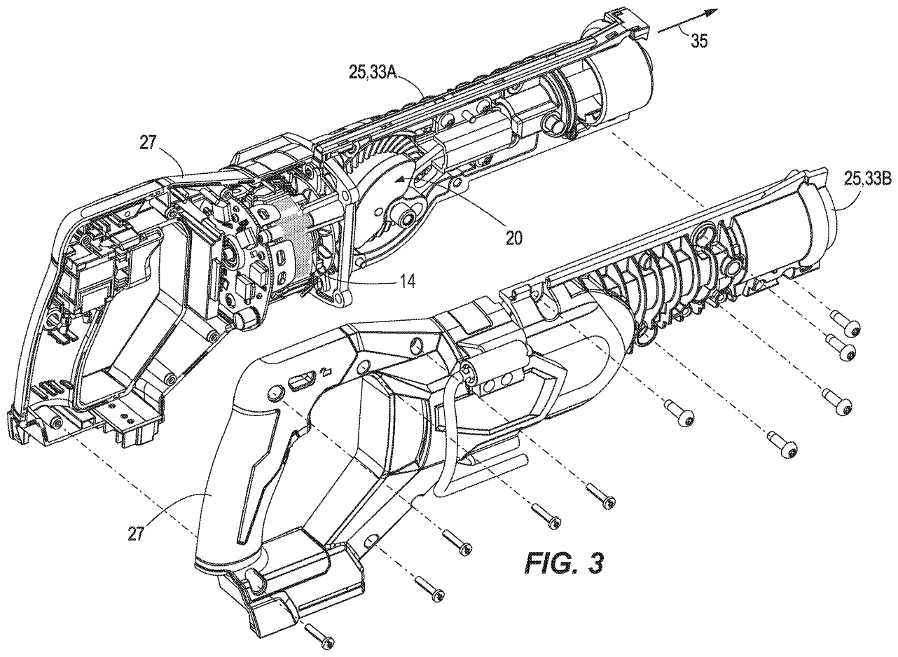

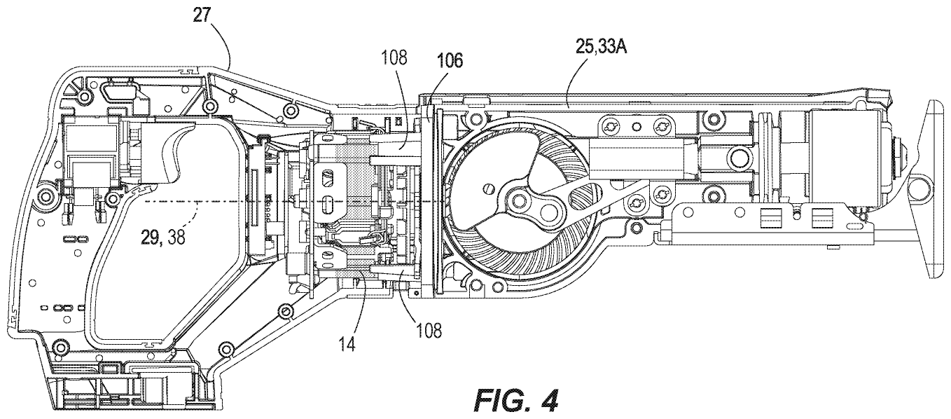

With reference to FIGS. 1-4, the housing 12 includes a gear case 25 and a rear housing portion 27 coupled to the gear case 25. The housing 12 also defines a longitudinal axis 29 (FIG. 4) that extends through the gear case 25 and the rear housing portion 27. The rear housing portion 27 includes a D-shaped handle 31 that supports the trigger 24. The gear case 25 includes first and second clamshell halves 33A, 33B coupled to one another along a mating plane 35 (FIG. 3). In the illustrated embodiment, the clamshell halves 33A, 33B are secured together with threaded fasteners (e.g., screws).

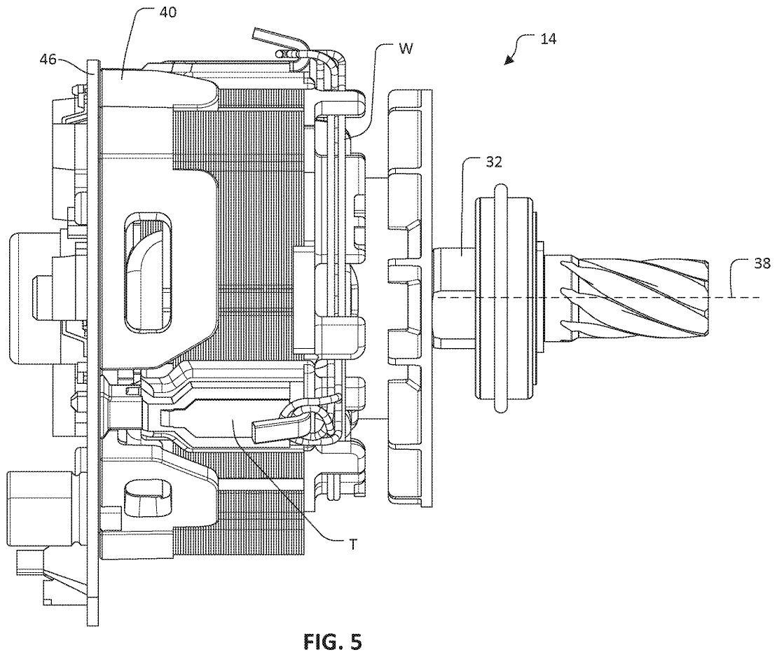

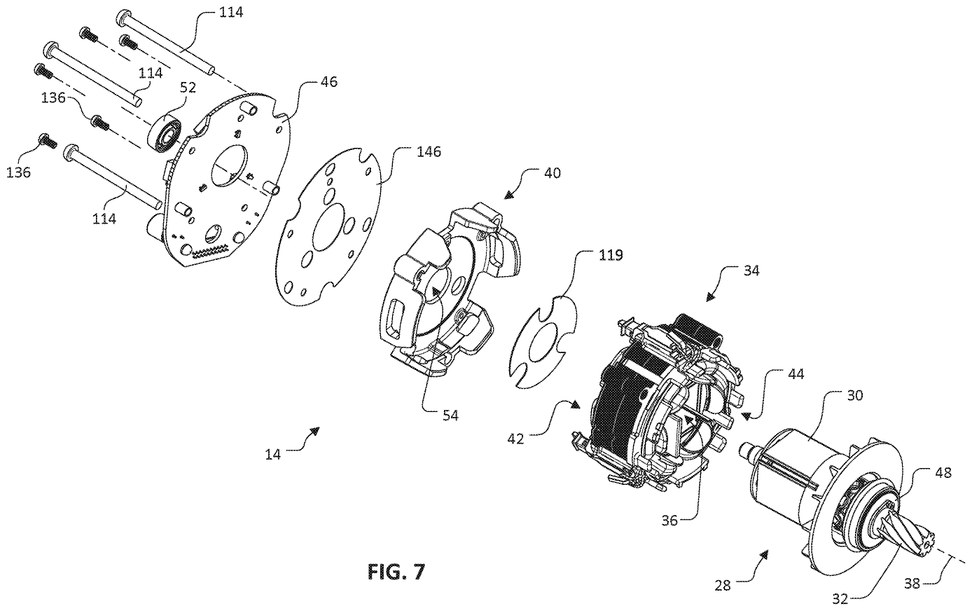

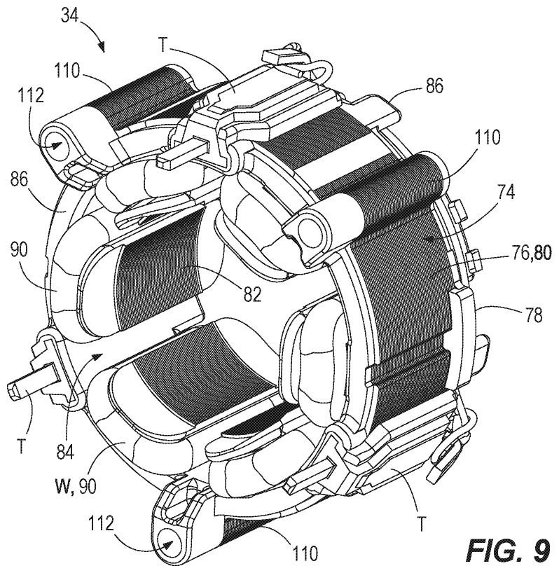

With reference to FIGS. 5-8, the illustrated motor 14 includes a rotor assembly 28 having a rotor body 30 fixed to a motor shaft 32, which couples to the drive mechanism 20 (FIG. 3). The motor 14 also includes a stator assembly 34 defining a central cavity 36 that receives the rotor assembly 28 to rotate about a motor axis 38. The rotor body 30 includes a rotor core 37, a plurality of permanent magnets 39, and a fan 41. The motor 14 further includes a heat sink 40 coupled to a rear end 42 of the stator assembly 34 opposite a front end 44, and a printed circuit board assembly 46 (or PCBA 46) coupled to the heat sink 40. A front portion of the motor shaft 32 is rotatably supported by a first bearing 48, which, in the illustrated embodiment, is seated within a front bearing pocket 50 (FIG. 10) of the gear case 25. Likewise, a rear portion of the motor shaft 32 is rotatably supported by a second bearing 52, which is seated within a rear bearing pocket 54 defined by the heat sink 40. In some embodiments, the second bearing 52 can be press-fit into the rear bearing pocket 54 of the heat sink 40.

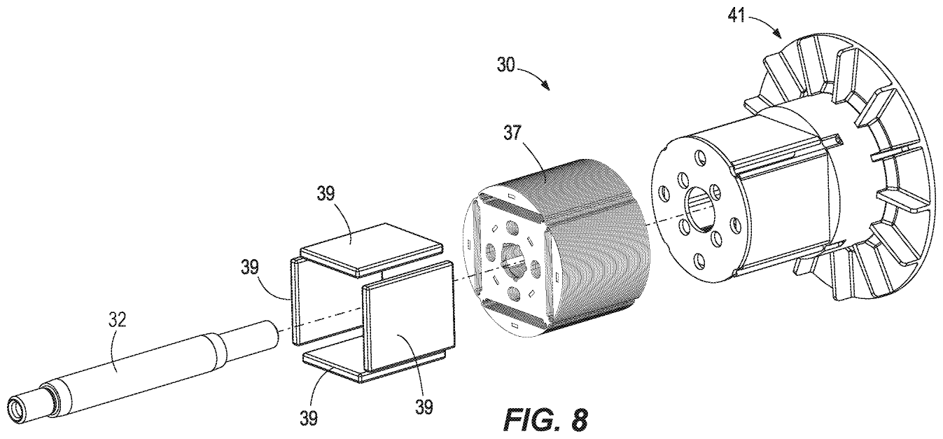

With reference to FIG. 9, the stator assembly 34 includes a stator body 74 having a stator core 76 (e.g., a lamination stack) and an insulator 78 formed of an insulative material (e.g., plastic) coupled to the stator core 76. In the illustrated embodiment, the stator core 76 includes an annular yoke 80 and six teeth 82 extending radially inward from the yoke 80. The yoke 80 and adjacent pairs of the teeth 82 define stator slots 84 therebetween. The insulator 78 includes a pair of end insulators or bobbins 86 disposed at each axial end face of the stator core 76.

A plurality of windings W are routed through the slots 84 and wound about the respective teeth 82 to form coils 90. The windings W can be formed from elongated conductive wires and are electrically connected to a plurality of terminals T. The terminals T are electrically connected to the PCBA 46, which selectively directs current to the windings W, causing the rotor assembly 28 to rotate about the motor axis 38.

As shown in FIGS. 4 and 10, the motor 14 is positioned within the rear housing portion 27 and affixed to the gear case 25. In the illustrated embodiment, the motor axis 38 of the motor 14 is generally aligned or coaxial with the longitudinal axis 29 of the housing 12. The first clamshell half 33A includes a rear wall 106 that extends generally orthogonal to the longitudinal axis 29. The front bearing pocket 50 is formed in the rear wall 106, and the first bearing 48 is received into the front bearing pocket 50.

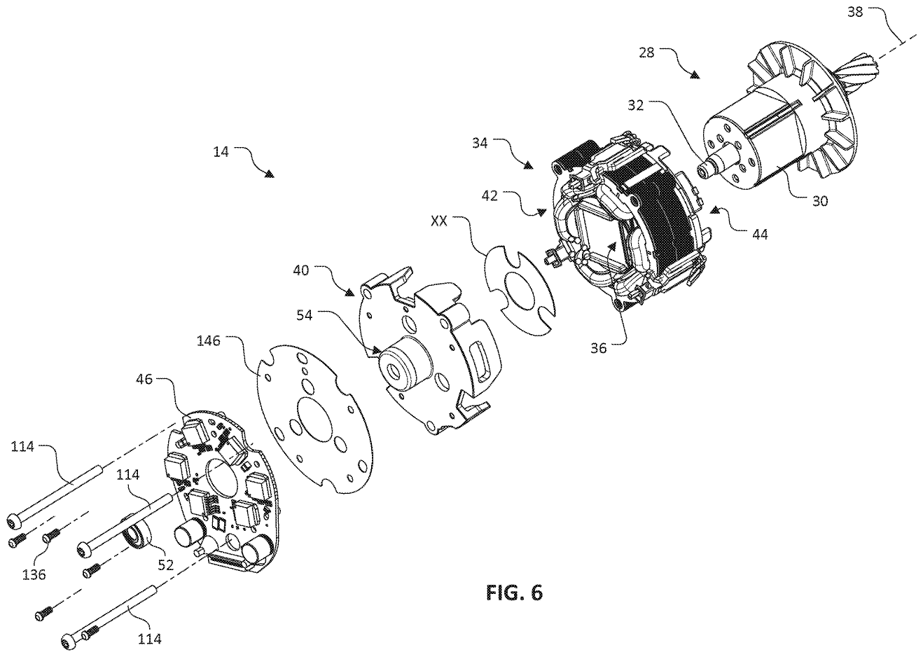

With reference to FIGS. 4, 9, and 10, the motor 14 is supported by a plurality of motor mounting legs 108 that extend from the rear wall 106 toward the rear housing portion 27 along an axial direction generally parallel to the longitudinal axis 29. The mounting legs 108 correspond to and align with mounting ribs 110, which project radially outward from the stator body 74. Axially-extending mounting apertures 112 are defined within the mounting ribs 110 and receive fasteners 114 (FIG. 6) for securing the motor 14 to the gear case 25. In the illustrated embodiment, there are three mounting legs 108 projecting from the gear case 25 and corresponding to three mounting ribs 110, which form three respective mounting apertures 112. In other embodiments, there may be fewer (e.g., two) or more (e.g., four, five, etc.) mounting legs 108 and corresponding mounting ribs 110. Each mounting leg 108 defines a threaded aperture 116 proximate the rear wall 106. The fasteners 114 extend through the mounting apertures 112 of the stator body 74 and thread into the threaded apertures 116 to secure the motor 14 to the gear case 25.

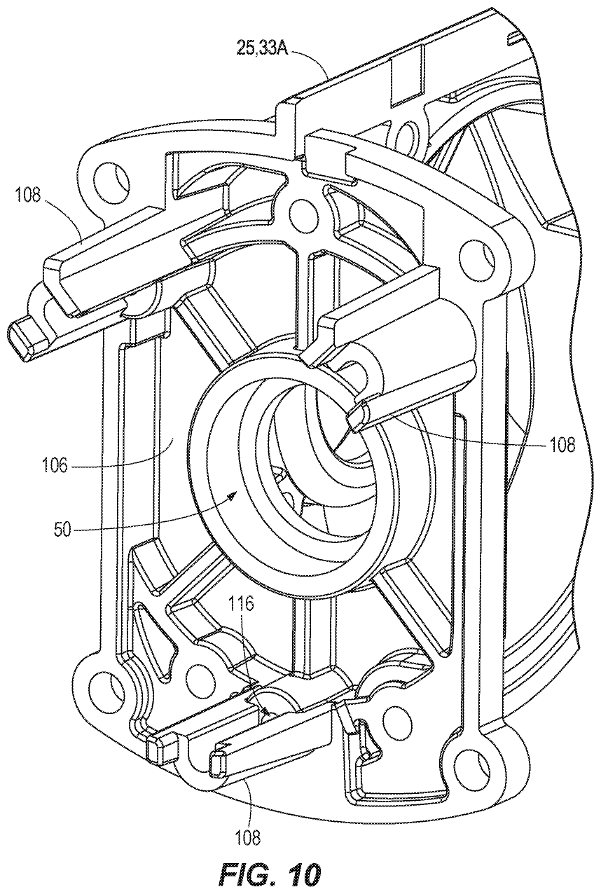

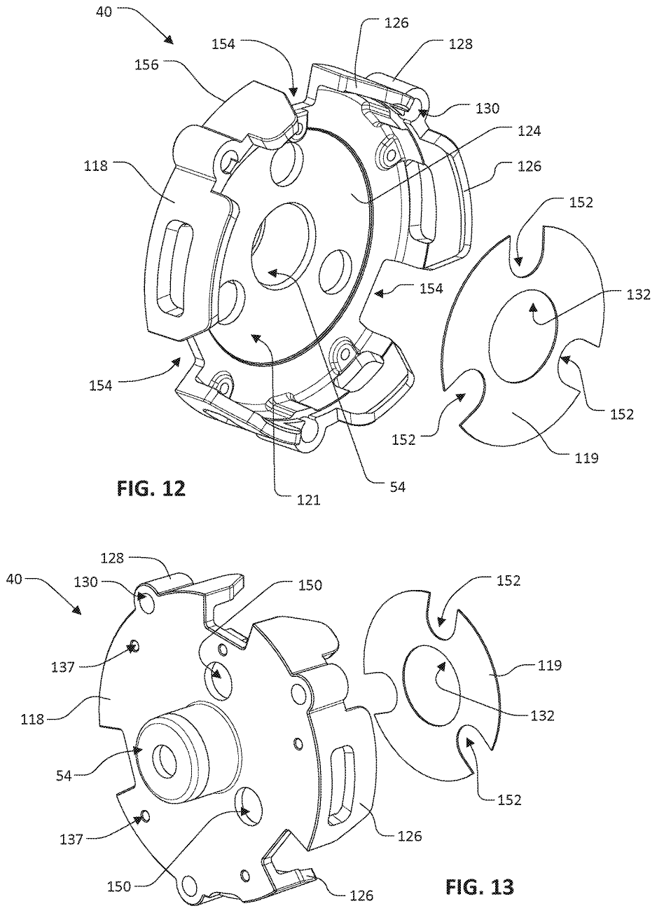

With reference to FIGS. 9-13, the heat sink 40 has a multi-layer construction and includes a main body 118 and a magnetic isolator 119. The main body 118 may be formed from a material having relatively high thermal conductivity, such as metal, in order to effectively conduct heat away from the PCBA 46. In the illustrated embodiment, the main body 118 is made from aluminum, i.e., a non-ferromagnetic and substantially non-magnetic material having high thermal and electrical conductivity. The main body 118 is generally cup-shaped and includes an end wall 124 that mates with a substrate board 120 of the PCBA 46 (FIG. 14). The main body 118 also includes the rear bearing pocket 54 and a plurality of axially-extending cooling flanges 126. The cooling flanges 126 are spaced about a periphery of the end wall 124 and extend axially toward the stator body 74. The main body 118 also includes mounting tabs 128 which extend radially outward from the perimeter of the end wall 124 and define fastener apertures 130 corresponding to the mounting ribs 110 and associated mounting apertures 112 of the stator body 74.

The magnetic isolator 119 is made from a magnetic material, such as a ferromagnetic material. In the illustrated embodiment, the magnetic isolator 119 is made of steel and is formed as a thin sheet or plate coupled to a first side 121 of the main body 118 facing toward the rotor assembly 28. The magnetic isolator 119 is annular in shape and defines a central aperture 132 which permits the motor shaft 32 to pass therethrough. In some examples, the magnetic isolator 119 can be made of steel, such as lamination grade steel, and can have a thickness of 0.35 millimeters (mm). In other examples, the magnetic isolator 119 can have a thickness of greater than 0.10 mm and less than 1.00 mm. As will be discussed herein, the magnetic isolator 119 effects a disruption of electrical eddy currents induced in the main body 118 during operation of the motor 14.

In some embodiments, the heat sink 40 further includes an adhesive (not shown) that adheres the magnetic isolator 119 to the first side 121 of the main body 118. In some examples, the magnetic isolator 119 can be formed by a stamping process by which the magnetic isolator 119 is stamped from a raw material lamination sheet, and the adhesive can be pre-applied to the lamination sheet prior to the stamping process. The adhesive can be a high-temp, non-liquid adhesive, such as a pressure-sensitive transfer tape. The transfer tape can initially include a backing. During assembly of the heat sink 40, the backing can be removed, and a fixture can properly align the magnetic isolator 119 with the main body 118. Once aligned, pressure can be applied (e.g., via a press) to fix the magnetic isolator 119 to the main body 118 via the transfer tape. In other examples, the magnetic isolator 119 can be coupled to the main body 118 by other means or processes, such as swaging, heat staking, or with fasteners (e.g., screws).

When the gear case 25 is assembled with the motor 14, the fasteners 114 extend through the fastener apertures 130 and the mounting apertures 112, and thread into the threaded apertures 116 of the gear case 25. By tightening the fasteners 114, the heat sink 40 and the mounting legs 108 apply a clamping force to the stator body 74, thereby fixing the stator body 74 to the heat sink 40 and to the mounting legs 108.

With reference to FIGS. 6 and 11-15, the substrate board 120 of the PCBA 46 is coupled to the heat sink 40 via PCBA fasteners 136. Specifically, the substrate board 120 defines mounting apertures 134, and the heat sink 40 defines corresponding threaded apertures 137 arranged to align with the mounting apertures 134 and receive the PCBA fasteners 136 to secure the PCBA 46 to the heat sink 40.

The PCBA 46 also includes heat-generating components 140 (e.g., semiconductor FETs, current sense resistors, thermistors, capacitors, diodes, voltage sensors, etc.) supported on a first side 142 of the substrate board 120 facing away from the heat sink 40. A second side 144 of the substrate board 120 faces toward the heat sink 40. In the illustrated embodiment, a thermal pad 146 (FIG. 6) (e.g., a highly thermal conductive member) is positioned between the substrate board 120 and the heat sink 40. The thermal pad 146 may be arranged in contact with the second side 144 of the substrate board 120 and with the end wall 124 of the main body 118. In other embodiments, the thermal pad 146 can be omitted such that the substrate board 120 directly contacts the heat sink 40.

In the illustrated embodiment, the PCBA 46 also includes position sensors 148 (e.g., Hall effect sensors) located on the second side 144 of the substrate board 120. The position sensors 148 are operable to detect a position of the rotor assembly 28. The main body 118 of the heat sink 40 defines a plurality of sensing apertures 150 which align with the position sensors 148. The magnetic isolator 119 likewise includes a plurality of recesses 152 (e.g., cutouts) that are aligned with the position sensors 148 and with the sensing apertures 150. As such, the heat sink 40 does not obstruct the position sensors 148 from sensing the position of the rotor assembly 28.

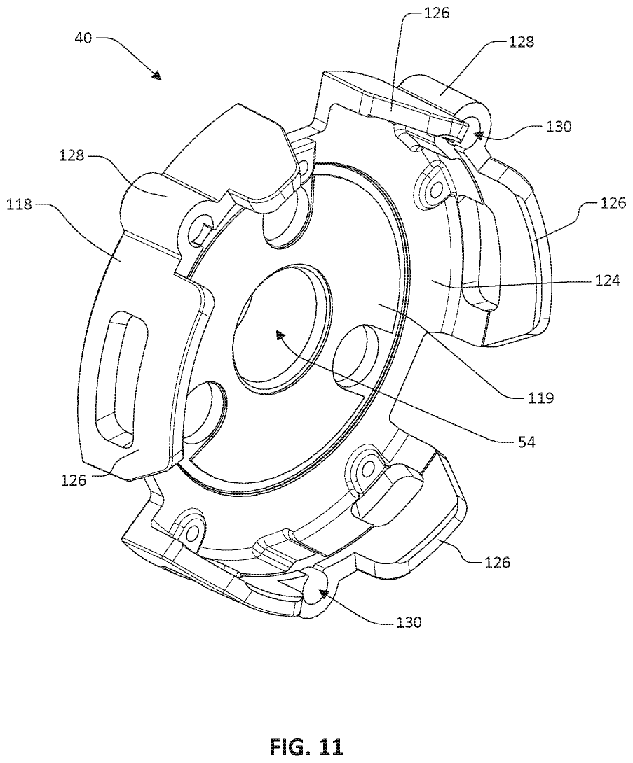

As shown in FIG. 9, in the illustrated embodiment, the motor 14 includes three terminals T that are longitudinally arranged along an outer periphery of the stator body 74 and spaced apart from one another in the circumferential direction at generally equal intervals. Each terminal T comprises an elongated electrically conductive member formed from, e.g., copper, brass, etc. The terminals T are electrically connected to the windings W at the front end 44 of the stator assembly 34 and are electrically connected to the PCBA 46 at the rear end 42 of the stator assembly 34. The terminals T conduct electrical current between the PCBA 46 and the windings W. As shown in FIG. 12, the main body 118 of the heat sink 40 defines a plurality of notches 154 in an outer periphery, or a peripheral edge 156, of the end wall 124. The terminals T extend through the notches 154 and are soldered to the PCBA 46.

In operation, the battery pack 16 supplies power to the PCBA 46 and to the motor 14. The heat-generating components 140 selectively direct current to the windings W of the stator assembly 34, which causes the rotor assembly 28 to rotate about the motor axis 38 and operate the drive mechanism 20. The electrical current flowing through the heat-generating components 140 generates heat (i.e., thermal energy). At least some of the heat generated is conducted to the heat sink 40 and dissipated away from the stator body 74 and the rotor assembly 28. In particular, the heat generated by the heat-generating components 140 conducts through the thermal pad 146 to the end wall 124, and from the end wall 124 to the cooling flanges 126. At least some of the heat is dissipated away from the cooling flanges 126 by convection effected by an airflow generated by the fan 41.

During operation of the motor 14, current flows intermittently through the windings W, which intermittently induces magnetic fields with shifting orientations. The magnetic fields attributable to the windings W can induce eddy currents in the main body 118 of the heat sink 40. In addition, the permanent magnets 39 of the rotor assembly 28 orbit about the motor axis 38. The heat sink 40 is also exposed to moving magnetic fields attributable to the motion of the permanent magnets 39. These magnetic fields can also induce eddy currents in the main body 118 of the heat sink 40. The eddy currents can generate heat within the heat sink 40. The eddy currents can also generate their own secondary magnetic fields which ultimately exert drag forces on the rotor assembly 28. The magnetic isolator 119 interrupts the eddy currents induced in the main body 118 and generally reduces their heat generation and drag-inducing effects.

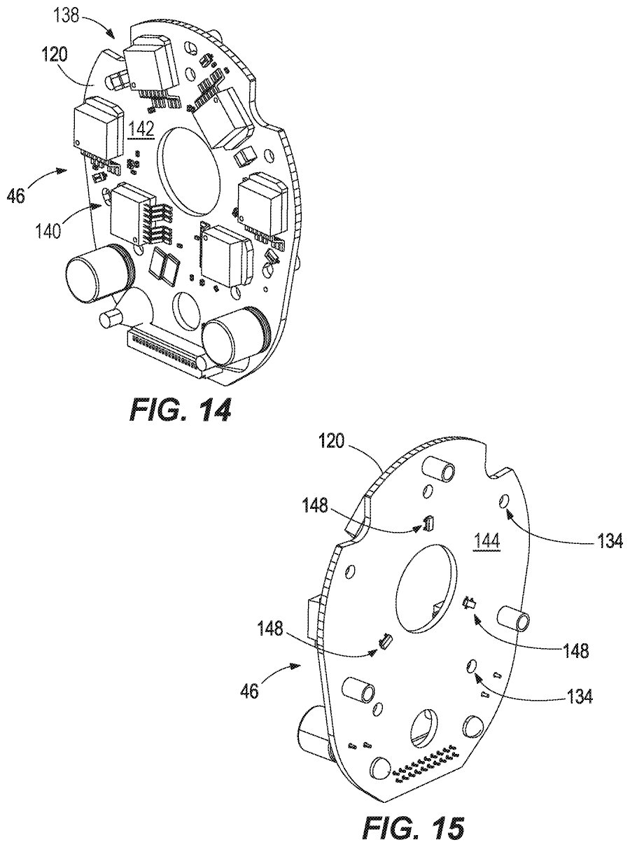

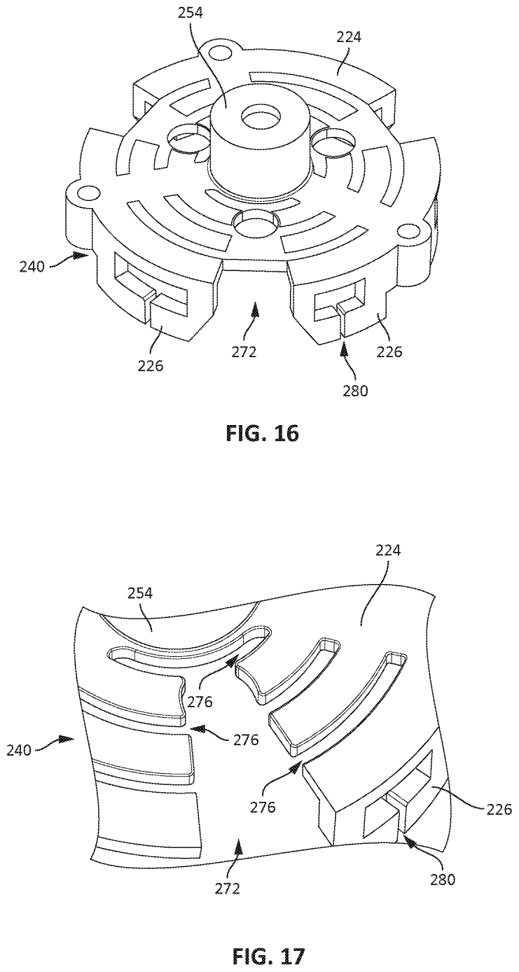

FIGS. 16 and 17 illustrate a heat sink 240 according to another embodiment, which can be incorporated into the motor 14 in place of the heat sink 40 heretofore described. The heat sink 240 includes multiple features similar to those of the heat sink 40, with like features having the same reference numbers in the “200” series. Like the heat sink 40 described herein, the heat sink 240 includes features that prevent or disrupt the formation of eddy currents in a material of the heat sink 240 during operation of the electric motor 14.

Unlike the heat sink 40, the heat sink 240 does not include a magnetic isolator separate from a main body. Instead, the heat sink 240 comprises only a main body that is made from a material having relatively high thermal conductivity, such as metal. In the illustrated embodiment, the heat sink 240 is made of aluminum, i.e., a non-ferromagnetic and substantially non-magnetic material having high thermal and electrical conductivity. The heat sink 240 includes a rear bearing pocket 254, an end wall 224, and a plurality of fins or cooling flanges 226. The rear bearing pocket 254 supports the second bearing 52, which supports the motor shaft 32. The end wall 224 extends normal to an axial direction of the electric motor 14, or normal to the motor axis 38, or transverse to the motor axis 38, and thermally conducts heat away from the PCBA 46. The cooling flanges 226 are arranged about a periphery of the end wall 224 and bend toward the axial direction. The cooling flanges 226 dissipate heat by convection due to the airflow induced by a fan of the rotor assembly 28.

The heat sink 240 defines a plurality of notches including primary notches 272, secondary notches 276, and fin notches 280. The primary notches 272 extend radially from a periphery of the end wall 224 to the rear bearing pocket 254. The secondary notches 276 are shaped as arcing or curving segments, or arcuate recesses, which communicate with the primary notches 272. The secondary notches 276 open to the primary notches 272 and extend away from the primary notches 272 in a circumferential direction. When the PCBA 46 is fastened to the heat sink 240, the position sensors 148 (FIG. 15) are accommodated within the primary notches 272.

In operation, current flows intermittently through the windings W, which intermittently induces magnetic fields, with shifting orientations, to which the heat sink 240 is exposed. The permanent magnets 39 of the rotor assembly 28 move due to rotation of the rotor assembly 28, which also exposes the heat sink 240 to moving magnetic fields. These magnetic fields induce eddy currents in the heat sink 240, which are loops of electric current induced within conductors. The eddy currents can generate heat within the heat sink 240. The eddy currents can also generate their own secondary magnetic fields which ultimately exert drag forces on the rotor assembly 28. The notches 272, 276, 280 interrupt the conductive material of the heat sink 240 with open spaces (or, spaces occupied by ambient air), which resist the flow of eddy currents. Thus, the arrangement of notches 272, 276, 280 results in reduced eddy currents induced in the heat sink 240, which improves heat dissipation performance and reduces drag on the motor 14.

Although the disclosure has been described in detail with reference to certain preferred embodiments, variations and modifications exist within the scope and spirit of one or more independent aspects of the disclosure as described. Various features and/or advantages of the disclosure are set forth in the following claims.

What is claimed is:

1. An electric motor assembly comprising:
a stator assembly including a stator body having a plurality of teeth, and windings wound about the stator body to form a plurality of coils;
a rotor assembly configured to rotate relative to the stator assembly;
a circuit board assembly coupled to the stator assembly and electrically connected to the windings; and
a heat sink coupled to the circuit board assembly, the heat sink including a main body positioned in thermal contact with the circuit board assembly, and a magnetic isolator coupled to the main body, the magnetic isolator configured to reduce eddy currents induced in the main body during operation of the electric motor assembly.

2. The electric motor assembly of claim 1, wherein the main body is formed from a non-ferromagnetic material.

3. The electric motor assembly of claim 1, wherein the magnetic isolator is formed from a ferromagnetic material.

4. The electric motor assembly of claim 3, wherein the magnetic isolator comprises a sheet positioned between the main body and the rotor assembly.

5. The electric motor assembly of claim 4, wherein the magnetic isolator defines a central aperture, and wherein the rotor assembly includes a motor shaft that extends through the central aperture.

6. The electric motor assembly of claim 4, wherein the magnetic isolator directly contacts the main body.

7. The electric motor assembly of claim 1, wherein the circuit board assembly is mounted to an end wall of the main body with a thermal pad disposed therebetween.

8. An electric motor assembly comprising:
a stator assembly including a stator body having a plurality of teeth, and windings wound about the stator body to form a plurality of coils;
a rotor assembly configured to rotate relative to the stator assembly about a rotational axis;
a circuit board assembly coupled to the stator assembly and electrically connected to the windings; and
a heat sink coupled to the circuit board assembly, the heat sink including an end wall oriented transverse to the rotational axis, the end wall defining:
(a) a plurality of primary notches extending radially inward from a peripheral edge of the end wall, and
(b) a plurality of secondary notches each communicating with a corresponding primary notch of the plurality of primary notches and extending circumferentially relative to the rotational axis.

9. The electric motor assembly of claim 8, wherein the heat sink is formed from a non-ferromagnetic material.

10. The electric motor assembly of claim 9, wherein the heat sink is formed from aluminum.

11. The electric motor assembly of claim 8, wherein the heat sink is positioned between the circuit board assembly and the rotor assembly.

12. The electric motor assembly of claim 8, wherein the plurality of primary notches and the plurality of secondary notches are configured to reduce eddy currents induced in the heat sink during operation of the electric motor assembly.

13. The electric motor assembly of claim 8, wherein the heat sink further includes cooling fins extending axially from the end wall.

14. The electric motor assembly of claim 8, wherein the heat sink further includes a bearing pocket configured to support a motor bearing, and wherein the primary notches extend from the peripheral edge of the end wall toward the bearing pocket.

15. The electric motor assembly of claim 8, wherein the secondary notches comprise arcuate recesses extending circumferentially between adjacent primary notches.

16. The electric motor assembly of claim 8, wherein the end wall further defines apertures aligned with position sensors mounted on the circuit board assembly.

17. A power tool comprising:
a housing;
a drive mechanism supported by the housing;
and an electric motor assembly supported within the housing and configured to drive the drive mechanism, the electric motor assembly including:
a stator assembly having a stator body and windings wound about the stator body to form a plurality of coils,
a rotor assembly configured to rotate relative to the stator assembly,
a circuit board assembly electrically connected to the windings, and
a heat sink thermally coupled to the circuit board assembly and positioned adjacent the rotor assembly;
wherein the heat sink includes a main body and at least one eddy current reduction feature selected from:
(a) a magnetic isolator coupled to the main body, or
(b) a plurality of interrupting notches defined in an end wall of the main body.

18. The power tool of claim 17, wherein the heat sink further includes a bearing pocket configured to support a motor bearing.

19. The power tool of claim 17, wherein the main body includes an end wall, and wherein the plurality of interrupting notches include:
(a) a plurality of primary notches extending radially inward from a peripheral edge of the end wall, and
(b) a plurality of secondary notches each communicating with a corresponding primary notch of the plurality of primary notches and extending circumferentially relative to a rotational axis of the rotor assembly.

20. The power tool of claim 17, wherein the magnetic isolator is configured to reduce eddy currents induced in the main body during operation of the electric motor assembly.
